(19) United States
(12) Patent Application Publication
(10) Pub. No.: US 2024/0376239 A1
(43) Pub. Date: Nov. 14, 2024

(54) COPOLYMER, PIEZOELECTRIC MATERIAL, PIEZOELECTRIC FILM, AND PIEZOELECTRIC ELEMENT

(71) Applicant: TDK CORPORATION, Tokyo (JP)

(72) Inventor: Junichi HOSHINO, Tokyo (JP)

(73) Assignee: TDK CORPORATION, Tokyo (JP)

(21) Appl. No.: 18/686,522

(22) PCT Filed: Aug. 9, 2022
(86) PCT No.: PCT/JP2022/030423

§ 371 Date: Feb. 26, 2024

(30) Foreign Application Priority Data
Aug. 31, 2021 (JP) 2021-141397

(51) Int. Cl. C08F 220/44; C08F 226/02

(52) U.S. Cl. CPC C08F 220/44; C08F 226/02

(57) ABSTRACT

A copolymer has a structural unit represented by (1) (R is any one selected from a hydrogen atom, a methyl group, an ethyl group, a methoxymethyl group, a propyl group, an isopropyl group, a cyclopropyl group, a butyl group, an isobutyl group, a (trimethyl)methyl group, a pentyl group, an isopentyl group, a t-pentyl group, a neopentyl group, a cyclopentyl group, a hexyl group, a cyclohexyl group, an adamantyl group, a phenyl group optionally having a substituent, an o-, m- or p-acetamidophenyl group, an o-, m- or p-benzamide group, an o-, m- or p-(methyl)benzamide group, an o-, m- or p-(N,N-dimethyl)benzamide group, a benzyl group optionally having a substituent and a phenoxymethyl group) and a structural unit represented by (2).

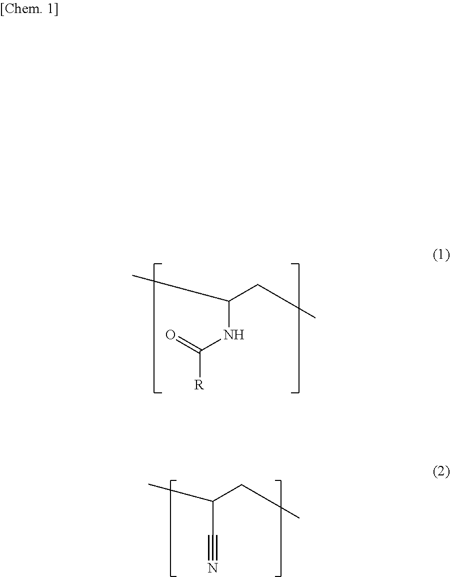

### TECHNICAL FIELD

The present invention relates to a copolymer, a piezoelectric material, a piezoelectric film, and a piezoelectric element.

Priority is claimed on Japanese Patent Application No. 2021-141397, filed Aug. 31, 2021, the content of which is incorporated herein by reference.

### BACKGROUND ART

Conventionally, PZT (PbZrO₃—PbTiO₃-based solid solution), which is a ceramic material, has been often used as a piezoelectric material that forms piezoelectric bodies in piezoelectric elements. However, PZT is a ceramic containing lead and thus has a disadvantage of being brittle. Therefore, there is a demand for a highly flexible material with a low environmental impact as a piezoelectric material.

As a piezoelectric material that meets such a demand, the use of a polymer piezoelectric material is considered. As the polymer piezoelectric material, there are ferroelectric polymers such as polyvinylidene fluoride (PVDF) and a vinylidene fluoride-trifluoroethylene copolymer (P(VDF-TrFE)). However, these ferroelectric polymers are not sufficiently heat-resistant. Therefore, at high temperatures, piezoelectric bodies composed of a conventional ferroelectric polymer lose piezoelectric characteristics, and characteristics such as elastic modulus also deteriorate. Therefore, piezoelectric elements having a piezoelectric body composed of a conventional ferroelectric polymer could be used within a narrow temperature range.

In addition, as a piezoelectric material, there is an amorphous polymer piezoelectric material that acquires piezoelectricity when polarized and cooled at a temperature near the glass transition temperature. Amorphous polymers lose piezoelectric characteristics at temperatures near the glass transition temperatures. Therefore, there is a demand for a highly heat-resistant amorphous polymer piezoelectric material having a high glass transition temperature.

As an amorphous polymer piezoelectric material having a high glass transition temperature, there is a vinylidene cyanide-vinyl acetate copolymer (for example, refer to Patent Document 1). However, for the vinylidene cyanide-vinyl acetate copolymer, there is a need to use vinylidene cyanide that is hard to handle as a raw material monomer.

In addition, as a raw material monomer of polymer piezoelectric materials, the use of acrylonitrile that is easy to handle instead of vinylidene cyanide can be considered. However, polymers for which acrylonitrile is used as a raw material monomer have a low glass transition temperature. In addition, the polymers for which acrylonitrile is used as a raw material monomer also have poor piezoelectric characteristics (for example, refer to Non-Patent Document 1 and Non-Patent Document 2).

### CITATION LIST

### Patent Document

### [Paten Document 1]

PCT International Publication No. WO 1991/013922

### Non-Patent Document

### [Non-Patent Document 1]

H. Ueda, S. Carr, Piezoelectricity in Polyacrylonitrile. Polym J 16, 661 to 667 (1984).

### [Non-Patent Document 2]

H. von Berlepsch, W. Kunstler. Piezoelectricity in acrylonitrile/methylacrylate copolymer. Polymer Bulletin 19, 305 to 309 (1988).

### SUMMARY OF INVENTION

### Technical Problem

Conventionally, there is a demand for a polymer piezoelectric material from which a piezoelectric film having high heat resistance and piezoelectric characteristics can be obtained.

The present invention has been made in consideration of the aforementioned circumstance, and an object of the present invention is to provide a copolymer that can be used as a piezoelectric material from which a piezoelectric film having high heat resistance and piezoelectric characteristics can be obtained.

In addition, another object of the present invention is to provide a piezoelectric material which contains the copolymer of the present invention and from which a piezoelectric film having high heat resistance and piezoelectric characteristics can be obtained.

In addition, still another object of the present invention is to provide a piezoelectric film containing the piezoelectric material of the present invention and having high heat resistance and piezoelectric characteristics and a piezoelectric element having the piezoelectric film of the present invention and having high heat resistance and piezoelectric characteristics.

### Solution to Problem

In order to achieve the aforementioned objects, the following means is provided.

A copolymer according to one aspect of the present invention is a copolymer having a structural unit represented by the following general formula (1) and a structural unit represented by the following formula (2).

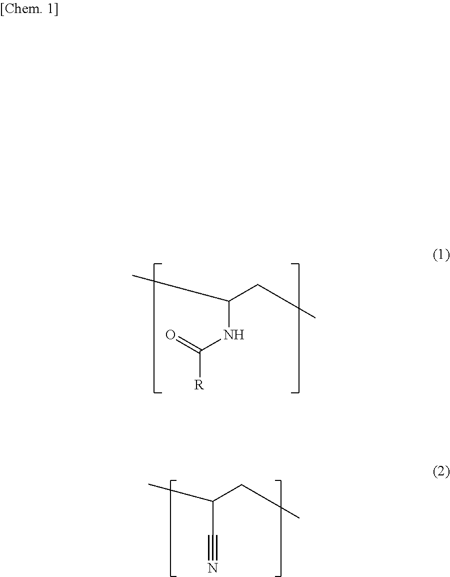

(in the general formula (1), R is any one selected from a hydrogen atom, a methyl group, an ethyl group, a methoxymethyl group, a propyl group, an isopropyl group, a cyclopropyl group, a butyl group, an isobutyl group, a (trimethyl)methyl group, a pentyl group, an isopentyl group, a t-pentyl group, a neopentyl group, a cyclopentyl group, a hexyl group, a cyclohexyl group, an adamantyl group, a phenyl group optionally having one to five substituents selected from a methyl group, an ethyl group, a methoxy group, an ethoxy group, a fluoro group, a trifluoromethyl group and a cyano group at any positions, an o-acetamidophenyl group, a m-acetamidophenyl group, a p-acetamidophenyl group, an o-benzamide group, a m-benzamide group, a p-benzamide group, an o-(methyl)benzamide group, a m-(methyl)benzamide group, a p-(methyl)benzamide group, an o-(N,N-dimethyl)benzamide group, a m-(N,N-dimethyl)benzamide group, a p-(N,N-dimethyl)benzamide group, a benzyl group optionally having one to five substituents selected from a methyl group, an ethyl group, a methoxy group, an ethoxy group, a fluoro group, a trifluoromethyl group and a cyano group at any positions and a phenoxymethyl group.)

### Advantageous Effects of Invention

The copolymer of the present invention has a structural unit represented by the general formula (1) and a structural unit represented by the formula (2). Therefore, the copolymer of the present invention can be used as a piezoelectric material from which a piezoelectric film having high heat resistance and piezoelectric characteristics can be obtained.

In addition, the piezoelectric material of the present invention contains the copolymer of the present invention, and a piezoelectric film having high heat resistance and piezoelectric characteristics can thus be obtained therefrom.

In addition, the piezoelectric film of the present invention contains the copolymer of the present invention. Therefore, the piezoelectric film of the present invention and the piezoelectric element of the present invention having the piezoelectric film of the present invention are excellent in terms of heat resistance and piezoelectric characteristics.

### BRIEF DESCRIPTION OF DRAWINGS

FIG. 1 is a ¹H-NMR measurement chart of a polymer of Example 3.

FIG. 2 is an enlarged view in which a part of FIG. 1 is enlarged.

FIG. 3 is an enlarged view in which a pan of FIG. 1 is enlarged.

FIG. 4 is a ¹H-NMR measurement chart of a polymer of Example 10.

FIG. 5 is an enlarged view in which a pan of FIG. 4 is enlarged.

FIG. 6 is a ¹H-NMR measurement chart of a polymer of Example 15.

FIG. 7 is an enlarged view in which a part of FIG. 6 is enlarged.

FIG. 8 is an enlarged view in which a part of FIG. 6 is enlarged.

FIG. 9 is a ¹H-NMR measurement chart of a polymer of Example 20.

FIG. 10 is an enlarged view in which a part of FIG. 9 is enlarged.

FIG. 11 is an enlarged view in which a part of FIG. 9 is enlarged.

FIG. 12 is a ¹H-NMR measurement chart of a polymer of Example 25.

FIG. 13 is an enlarged view in which a part of FIG. 12 is enlarged.

FIG. 14 is an enlarged view in which a pan of FIG. 12 is enlarged.

### DESCRIPTION OF EMBODIMENTS

In order to achieve the aforementioned objects, the present inventors paid attention to the heat resistance of a polymer for which acrylonitrile is used as a raw material monomer and repeated intensive studies.

As a result, the present inventors found that it is preferable to make a copolymer have a specific structural unit having a secondary amide skeleton (R—C(═OH)═NH—) and a structural unit derived from acrylonitrile.

A compound having a vinyl group bonding to a nitrogen atom in a secondary amide skeleton has a high affinity to acrylonitrile. Therefore, the compound having a vinyl group bonding to a nitrogen atom in a secondary amide skeleton is capable of forming a copolymer with acrylonitrile. In addition, when copolymerized with acrylonitrile, the compound having a vinyl group bonding to a nitrogen atom in a secondary amide skeleton forms a copolymer having a high glass transition temperature (Tg) and favorable heat resistance compared with polyacrylonitriles.

In more detail, a hydrogen atom in the amide skeleton that is included in the compound having a vinyl group bonding to a nitrogen atom in a secondary amide skeleton has a property of donating a hydrogen bond. On the other hand, a nitrile group that is a polar group included in acrylonitrile has a property of accepting a hydrogen bond. Therefore, a copolymer having a structural unit including a secondary amide skeleton and a structural unit derived from acrylonitrile is in a state where an ordered structure that can be formed by the nitrile group that is included in the structural unit derived from acrylonitrile has been disarrayed due to the structural unit including the secondary amide skeleton having a property of donating a hydrogen bond. As a result, a plurality of nitrile groups derived from acrylonitrile in the copolymer are less likely to be oriented such that the polarities cancel each other out. It is presumed that this makes it possible for the copolymer having a structural unit including a secondary amide skeleton and a structural unit derived from acrylonitrile to be a piezoelectric material from which a piezoelectric film having favorable heat resistance and piezoelectric characteristics can be obtained.

Furthermore, the present inventors produced a copolymer having a specific structural unit including a secondary amide skeleton and a structural unit derived from acrylonitrile, confirmed that the heat resistance of the copolymer was favorable and the piezoelectric characteristics of a piezoelectric film for which the copolymer was used as a piezoelectric material were favorable and obtained an idea of the present invention.

The present invention includes the following aspects.

[1] A copolymer having a structural unit represented by the following general formula (1) and a structural unit represented by the following formula (2).

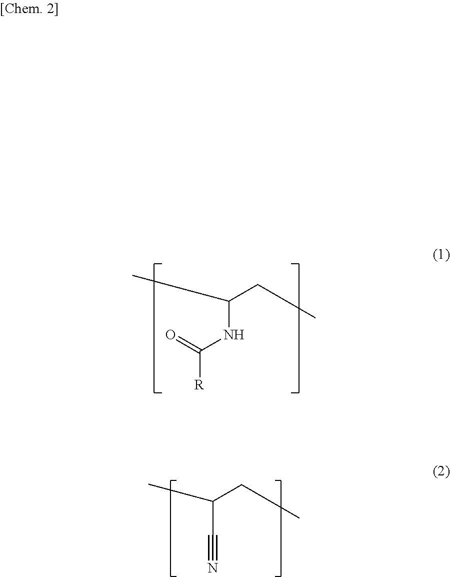

(in the general formula (1), R is any one selected from a hydrogen atom, a methyl group, an ethyl group, a methoxymethyl group, a propyl group, an isopropyl group, a cyclopropyl group, a butyl group, an isobutyl group, a (trimethyl)methyl group, a pentyl group, an isopentyl group, a t-pentyl group, a neopentyl group, a cyclopentyl group, a hexyl group, a cyclohexyl group, an adamantyl group, a phenyl group optionally having one to five substituents selected from a methyl group, an ethyl group, a methoxy group, an ethoxy group, a fluoro group, a trifluoromethyl group and a cyano group at any positions, an o-acetamidophenyl group, a m-acetamidophenyl group, a p-acetamidophenyl group, an o-benzamide group, a m-benzamide group, a p-benzamide group, an o-(methyl)benzamide group, a n-(methyl)benzamide group, a p-(methyl)benzamide group, an o-(N,N-dimethyl)benzamide group, a m(N,N-dimethyl)benzamide group, a p-(N,N-dimethyl)benzamide group, a benzyl group optionally having one to five substituents selected from a methyl group, an ethyl group, a methoxy group, an ethoxy group, a fluoro group, a trifluoromethyl group and a cyano group at any positions and a phenoxymethyl group.)

[2] The copolymer according to [1], in which, in the general formula (1), R is any one of a hydrogen atom, a methyl group, a butyl group, a phenyl group and a cyanophenyl group.

[3] The copolymer according to [1] or [2], in which a content of the structural unit represented by the formula (2) is 20 to 80 mol %.

[4] A piezoelectric material containing the copolymer according to any one of [1] to [3].

[5] A piezoelectric film containing the copolymer according to any one of [1] to [3].

[6] A piezoelectric element having the piezoelectric film according to [5] and an electrode disposed on a surface of the piezoelectric film.

Hereinafter, the copolymer, the piezoelectric material, the piezoelectric film and the piezoelectric element of the present invention will be described in detail.

### [Copolymer]

A copolymer of the present embodiment has a structural unit represented by a general formula (1) and a structural unit represented by a formula (2).

In the structural unit represented by the formula (1) in the copolymer of the present embodiment, R is any one selected from a hydrogen atom, a methyl group, an ethyl group, a methoxymethyl group, a propyl group, an isopropyl group, a cyclopropyl group, a butyl group, an isobutyl group, a (trimethyl)methyl group, a pentyl group (—CH₂—CH₂—CH₂—CH₂—CH₂—), an isopentyl group (—CH₂—CH₂—CH(CH₃)₂), a t-pentyl group (—C(CH₃)₂—C₂H₅), a neopentyl group, (—CH₂—C(CH₃)₃), a cyclopentyl group, a hexyl group, a cyclohexyl group, an adamantyl group, a phenyl group optionally having a substituent, an o-acetamidophenyl group, a m-acetamidophenyl group, a p-acetamidophenyl group, an o-benzamide group, a m-benzamide group, a p-benzamide group, an o-(methyl)benzamide group, a m-(methyl)benzamide group, a p-(methyl)benzamide group, an o-(N,N-dimethyl)benzamide group, a m-(N,N-dimethyl)benzamide group, a p-(N,N-dimethyl)benzamide group, a benzyl group optionally having a substituent and a phenoxymethyl group.

The phenyl group optionally having a substituent includes a phenyl group having a substituent and an unsubstituted phenyl group, that is, a phenyl group.

The benzyl group optionally having a substituent includes a benzyl group having a substituent and an unsubstituted benzyl group, that is, a benzyl group.

In a case where R in the structural unit represented by the formula (1) is a phenyl group having a substituent or a benzyl group having a substituent, the position of the substituent is an arbitrary position. The number of the substituents is one to five. The substituent is any one selected from a methyl group, an ethyl group, a methoxy group, an ethoxy group, a fluoro group, a trifluoromethyl group and a cyano group. In a case where the phenyl group having a substituent or the benzyl group having a substituent has a plurality of substituents, the kinds of the substituents may be all different from each other or substituents of the same kind may be included.

The copolymer of the present embodiment can be easily produced since R in the structural unit represented by the formula (1) is as described above. In addition, the copolymer of the present embodiment can be used as a material for piezoelectric films having favorable heat resistance and piezoelectric characteristics since R in the structural unit represented by the formula (1) is as described above. R in the structural unit represented by the formula (1) is preferably any one of a hydrogen atom, a methyl group, a butyl group, a phenyl group and a cyanophenyl group. The position of a cyano group in the cyanophenyl group is an arbitrary position. The cyanophenyl group is more preferably a 3-cyanophenyl group. R in the structural unit represented by the formula (1) is more preferably a methyl group or a phenyl group since the copolymer can be used as a material for piezoelectric films having more favorable heat resistance and piezoelectric characteristics. Particularly. R in the structural unit represented by the formula (1) is still more preferably a phenyl group since the phenyl group has favorable hydrophobicity and is thus excellent in terms of polarization stability and, furthermore, the copolymer becomes a material for piezoelectric films from which excellent heat resistance can be obtained due to a n stacking effect.

In the copolymer of the present embodiment, the array order of the structural unit represented by the formula (1) and the structural unit represented by the formula (2), which are repeating units, is not particularly limited. In addition, in the copolymer of the present embodiment, the number of the structural units represented by the formula (I) and the number of the structural units represented by the formula (2) may be equal to or different from each other. Therefore, in the copolymer of the present embodiment, an alternate array part in which the structural unit represented by the formula (1) and the structural unit represented by the formula (2) are alternately arrayed, a random array part in which the structural unit represented by the formula (1) and the structural unit represented by the formula (2) are arrayed in no order and a block array part having a portion in which the structural unit represented by the formula (1) is continuously arrayed and a portion in which the structural unit represented by the formula (2) is continuously arrayed may be distributed in arbitrary proportions. The copolymer of the present embodiment preferably includes the alternate array part since nitrile groups that are included in the structural unit represented by the formula (2) are less likely to be oriented such that the polarities cancel each other out and the copolymer can be used as a piezoelectric material having favorable heat resistance and piezoelectric characteristics.

In the copolymer of the present embodiment, the content of the structural unit represented by the formula (1) is preferably 20 to 80 mol %, more preferably 20 to 70 mol % and still more preferably 30 to 70 mol %. When the content of the structural unit represented by the formula (1) is 20 mol % or more, the copolymer has more favorable heat resistance. In addition, when the content of the structural unit represented by the formula (1) is 80 mol % or less, it is possible to prevent piezoelectric films containing the copolymer from becoming hard and brittle due to an excessively high content of the structural unit represented by the formula (1). In addition, when the content of the structural unit represented by the formula (1) is 80 mol % or less, it is possible to suppress deterioration of the insulation resistance of the copolymer due to moisture absorption by the structural unit represented by the formula (1).

In the copolymer of the present embodiment, the content of the structural unit represented by the formula (2) is preferably 20 to 80 mol %, more preferably 30 to 80 mol % and still more preferably 30 to 70 mol %. When the content of the structural unit represented by the formula (2) is 20 mol % or more, flexible piezoelectric films having high insulation resistance can be formed from the copolymer. In addition, when the content of the structural unit represented by the formula (2) is 80 mol % or less, it becomes easy to ensure the content of the structural unit represented by the formula (1). As a result, the nitrile groups that are included in the structural unit represented by the formula (2) are less likely to be oriented such that the polarities cancel each other out, and it becomes possible to form piezoelectric films having more favorable heat resistance and piezoelectric characteristics from the copolymer.

The copolymer of the present embodiment may include one or more different structural units other than the structural unit represented by the formula (1) and the structural unit represented by the formula (2) as necessary. Examples of the different structural unit include structural units derived from a well-known monomer or oligomer having a polymerizable unsaturated bond.

Among the structural units that are included in the copolymer of the present embodiment, the total content of the structural unit represented by the formula (1) and the structural unit represented by the formula (2) is preferably 50 mass % or more and more preferably 80 mass % or more and may be 90 mass % or more or 100 mass % (the copolymer may include only the structural unit represented by the formula (1) and the structural unit represented by the formula (2)).

The weight-average molecular weight (Mw) of the copolymer of the present embodiment is preferably 10,000 to 1,000,000. When the weight-average molecular weight (Mw) of the copolymer is 10,000 or more, the film-forming property becomes favorable, and piezoelectric films containing the copolymer of the present embodiment can be easily produced. When the weight-average molecular weight (Mw) of the copolymer is 1,000,000 or less, the copolymer can be easily dissolved in a solvent, and piezoelectric films can be easily produced using an application liquid containing the copolymer dissolved in a solvent.

### “Method for Producing Copolymer”

The copolymer of the present embodiment can be produced by, for example, a method in which a compound from which the structural unit represented by the formula (1) is derived, a raw material monomer containing acrylonitrile and a polymerization initiator such as azobisbutyronitrile are used and radical-copolymerized by a well-known method.

Polymerization conditions such as the reaction temperature and the reaction time at the time of producing the copolymer of the present embodiment can be determined as appropriate depending on the composition of the raw material monomer or the like.

The compound from which the structural unit represented by the formula (1) is derived is a compound in which a secondary amide skeleton and an atom bonding to a carbon atom in the secondary amide skeleton are the same as those in the structural unit represented by the formula (1) and a vinyl group bonds to a nitrogen atom in the secondary amide skeleton. Specific examples of the compound from which the structural unit represented by the formula (1) is derived include N-vinyl-formamide, N-vinyl-acetamide, N-vinyl-propanamide, N-vinyl-2-methoxyacetamide, N-vinyl-butanamide, N-vinyl-2-methylpropanamide, N-vinyl-cyclopropanecarboxamide, N-vinyl-pentanamide, N-vinyl-3-methylbutanamide, N-vinyl-2,2-dimethylpropanamide-N-vinyl-hexanamide, N-vinyl-4-methylpentanamide, N-vinyl-3,3-dimethylbutanamide, N-vinyl-2,2-dimethylbutanamide, N-vinyl-cyclopentanecarboxamide, N-vinyl-heptanamide, N-vinyl-cyclohexanecarboxamide, N-vinyl-phenylamide, N-vinyl-4-methylbenzamide, N-vinyl-2-phenylacetamide, N-vinyl-2-phenoxyacetamide, N-vinyl-2-cyanophenylamide, N-vinyl-3-cyanophenylamide, N-vinyl-4-cyanophenylamide and the like, and the compound is determined as appropriate depending on the structure of the copolymer of the present embodiment, which is a target product.

“Piezoelectric material” A piezoelectric material of the present embodiment contains the copolymer of the present embodiment. The number of the kinds of the copolymers of the present embodiment that are contained in the piezoelectric material of the present embodiment may be one, or more. In addition, the piezoelectric material of the present embodiment may contain one or more kinds of well-known polymers other than the copolymer of the present embodiment together with the copolymer of the present embodiment as necessary.

### “Piezoelectric Film”

A piezoelectric film of the present embodiment contains the copolymer of the present embodiment.

The piezoelectric film of the present embodiment can be produced by, for example, a method to be described below. The piezoelectric material of the present embodiment containing the copolymer of the present embodiment is dissolved in a solvent to produce an application liquid. As the solvent, a well-known solvent such as N,N-dimethylformamide can be used. Next, the application liquid is applied onto a peelable base material in a predetermined thickness to form a coated film. As the base material, a well-known base material such as a resin film can be used. As a method for applying the application liquid, a well-known method can be used depending on the application thickness, the viscosity of the application liquid or the like. After that, the coated film is dried to remove the solvent in the coated film, thereby producing a piezoelectric material sheet. A stretching treatment may be performed on the piezoelectric material sheet as necessary.

After that, the piezoelectric material sheet is peeled off from the base material, and an electrode made of a well-known conductive material such as aluminum is installed on each of one surface and the other surface of the piezoelectric material sheet. In addition, a voltage is applied to the piezoelectric material sheet at a temperature near the glass transition temperature of the piezoelectric material that forms the piezoelectric material sheet through the electrodes installed on both surfaces. After that, the piezoelectric material sheet is cooled under the application of the voltage. Therefore, piezoelectricity is acquired. A sheet-like piezoelectric film can be obtained by the aforementioned steps.

The electrode used to acquire piezoelectricity may be used as it is as a member for forming a piezoelectric element or may be removed.

### “Piezoelectric Element”

A piezoelectric element of the present embodiment has the piezoelectric film of the present embodiment and an electrode disposed on a surface of the piezoelectric film. Specifically, a piezoelectric element having a sheet-like piezoelectric film and electrodes disposed on each of one surface and the other surface of the piezoelectric film can be exemplified. As a material of the electrode, a well-known conductive material such as aluminum can be used.

The piezoelectric element of the present embodiment can be produced by, for example, providing an electrode on each of one surface and the other surface of the piezoelectric film by a well-known metho such as a vapor deposition method.

The copolymer of the present embodiment has the structural unit represented by the general formula (1) and the structural unit represented by the formula (2). Therefore, the copolymer of the present embodiment can be used as a piezoelectric material from which piezoelectric films having high heat resistance and piezoelectric characteristics can be obtained.

In addition, the piezoelectric material of the present invention contains the copolymer of the present invention, and a piezoelectric film having high heat resistance and piezoelectric characteristics can thus be obtained therefrom.

In addition, the piezoelectric fila of the present invention contains the copolymer of the present invention. Therefore, the piezoelectric film of the present invention and the piezoelectric element of the present invention having the piezoelectric film of the present invention are excellent in terms of heat resistance and piezoelectric characteristics.

Hitherto, the embodiment of the present invention has been described in detail, but each configuration, a combination thereof and the like in each embodiment are simply examples, and addition, omission, substitution and other modification of the configuration are possible within the scope of the purport of the present invention.

### EXAMPLES

### Example 1

0.4 g (5.0 mmol) of N-vinyl-acetamide represented by the following general formula (11) and 1.3 ml (20 mmol) of acrylonitrile were mixed together in a 100 ml Schlenk tube, and 14.9 mg (0.09 mmol) of azobisisobutyronitrile was added thereto to react N-vinyl-acetamide and acrylonitrile at 60′C for two hours. A reaction product was injected into 200 ml of methanol to perform reprecipitation, and a precipitate was filtered and dried, thereby obtaining 1.1 g of a polymer of Example 1. The yield was 74%.

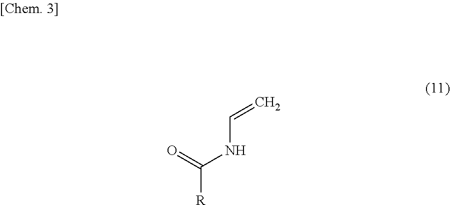

(in the general formula (11), R is a methyl group.)

¹H-NMR measurement was performed on the polymer of Example 1 using an NMR (nuclear magnetic resonance) device (trade name: JNM-EiCA500, manufactured by JEOL Ltd.) and dimethyl sulfoxide d6 (DMSO-d6) as a solvent to specify the molecular structure.

As a result, it was possible to confirm that the polymer of Example 1 was a copolymer having a structural unit represented by the general formula (1) (R in the general formula (1) was a methyl group) and a structural unit represented by the formula (2).

In addition, the composition ratio was calculated from the integrated value of each signal in the ¹H-NMR spectrum of Example 1. As a result, the content of the structural unit represented by the formula (2) that was included in the polymer of Example 1 was 83 mol %.

### Example 2

0.3 g (4.0 mmol) of N-vinyl-acetamide and 0.5 ml (8.0 mmol) of acrylonitrile were mixed together in a 10 ml Schlenk tube, and 7.6 mg (0.04 mmol) of azobisisobutyronitrile was added thereto to react N-vinyl-acetamide and acrylonitrile at 60° C. for two hours. A reaction product was injected into 200 ml of methanol to perform reprecipitation, and a precipitate was filtered and dried, thereby obtaining 0.4 g of a polymer of Example 2. The yield was 52%.

¹H-NMR measurement was performed on the polymer of Example 2 in the same manner as on the polymer of Example 1 to specify the molecular structure. As a result, it was possible to confirm that the polymer of Example 2 was, similar to the polymer of Example 1, a copolymer having a structural unit represented by the general formula (1) (R in the general formula (1) was a methyl group) and a structural unit represented by the formula (2).

In addition, the composition ratio was calculated from the integrated value of each signal in the ¹H-NMR spectrum of Example 2. As a result, the content of the structural unit represented by the formula (2) that was included in the polymer of Example 2 was 74 mol %.

### Example 3

0.7 g (8.0 mmol) of N-vinyl-acetamide and 0.8 ml (12.0 mmol) of acrylonitrile were mixed together in a 100 ml Schlenk tube, and 13.2 ng (0.08 mmol) of azobisisobutyronitrile was added thereto to react N-vinyl-acetamide and acrylonitrile at 60° C. for two hours. A reaction product was injected into 200 ml of methanol to perform reprecipitation, and a precipitate was filtered and dried, thereby obtaining 0.7 g of a polymer of Example 3. The yield was 53%.

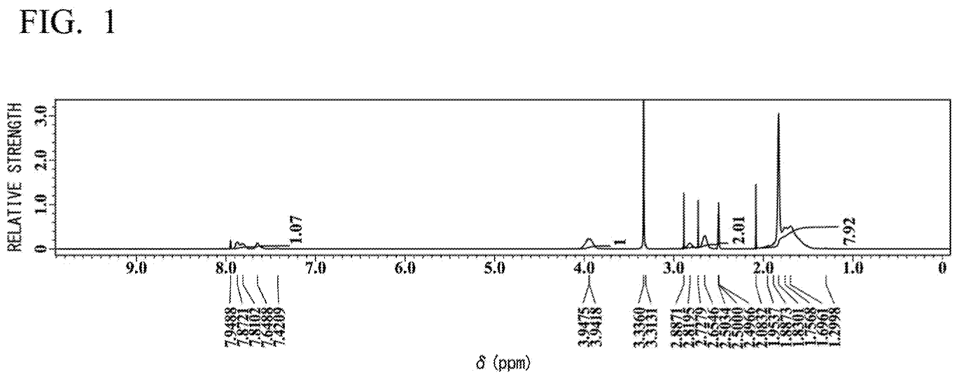

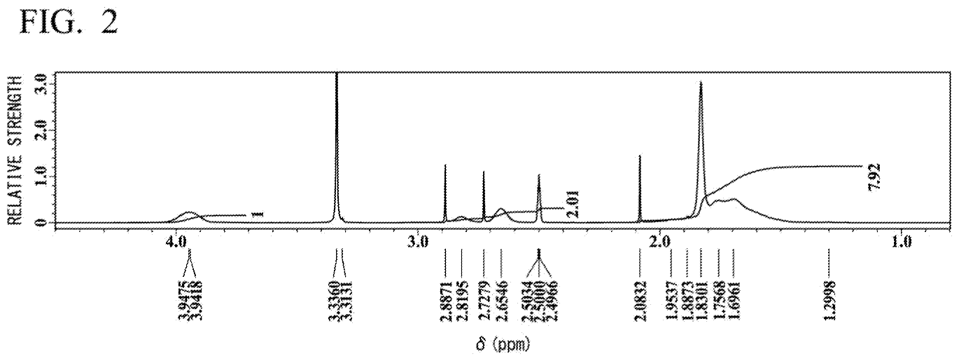

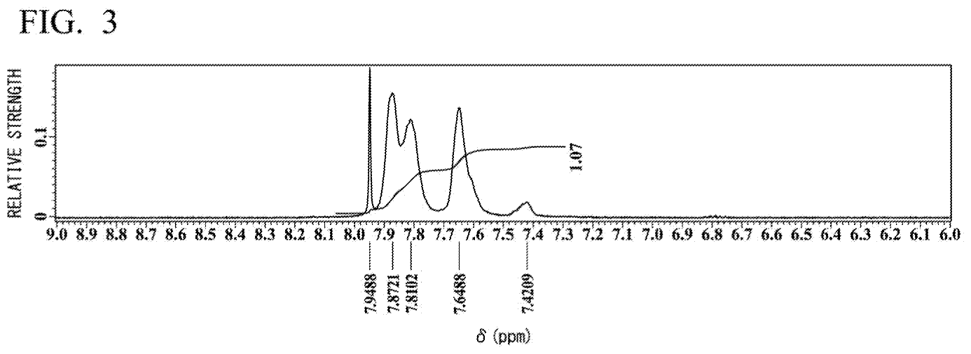

¹H-NMR measurement was performed on the polymer of Example 3 in the same manner as on the polymer of Example 1. FIG. 1 is the ¹H-NMR measurement chart of the polymer of Example 3. FIG. 2 and FIG. 3 are enlarged views in which a part of FIG. 1 is enlarged. In addition, regarding the polymer of Example 3, the molecular structure is specified using the result of the ¹H-NMR measurement. As a result, it was possible to confirm that the polymer of Example 3 was, similar to the polymer of Example 1, a copolymer having a structural unit represented by the general formula (1) (R in the general formula (1) was a methyl group) and a structural unit represented by the formula (2).

In addition, the composition ratio was calculated from the integrated value of each signal in the ¹H-NM R spectrum of Example 3. As a result, the content of the structural unit represented by the formula (2) that was included in the polymer of Example 3 was 60 mol %.

### Example 4

0.6 g (8.0 mmol) of N-vinyl-acetamide and 0.5 ml (8.0 mmol) of acrylonitrile were mixed together in a 100 ml Schlenk tube, and 11.1 my (0.07 mmol) of azobisisobutyronitrile was added thereto to react N-vinyl-acetamide and acrylonitrile at 60° C. for two hours. A reaction product was injected into 200 ml of methanol to perform reprecipitation, and a precipitate was filtered and dried, thereby obtaining 0.8 g of a polymer of Example 4. The yield was 72%.

¹H-NMR measurement was performed on the polymer of Example 4 in the same manner as on the polymer of Example 1 to specify the molecular structure. As a result, it was possible to confirm that the polymer of Example 4 was, similar to the polymer of Example 1, a copolymer having a structural unit represented by the general formula (1) (R in the general formula (1) was a methyl group) and a structural unit represented by the formula (2).

In addition, the composition ratio was calculated from the integrated value of each signal in the ¹H-NMR spectrum of Example 4. As a result, the content of the structural unit represented by the formula (2) that was included in the polymer of Example 4 was 44 mol %.

### Example 5

1.0 g (12.0 mmol) of N-vinyl-acetamide and 0.5 ml (8.0 mmol) of acrylonitrile were mixed together in a 100 ml Schlenk tube, and 14.5 mg (0.09 mmol) of azobisisobutyronitrile was added thereto to react N-vinyl-acetamide and acrylonitrile at 60° C. for two hours. A reaction product was injected into 200 ml of methanol to perform reprecipitation, and a precipitate was filtered and dried, thereby obtaining 0.9 g of a polymer of Example 5. The yield was 62%.

¹H-NMR measurement was performed on the polymer of Example 5 in the same manner as on the polymer of Example 1 to specify the molecular structure. As a result, it was possible to confirm that the polymer of Example 5 was, similar to the polymer of Example 1, a copolymer having a structural unit represented by the general formula (1) (R in the general formula (1) was a methyl group) and a structural unit represented by the formula (2).

In addition, the composition ratio was calculated from the integrated value of each signal in the ¹H-NMR spectrum of Example 5. As a result, the content of the structural unit represented by the formula (2) that was included in the polymer of Example 5 was 29 mol %.

### Example 6

0.9 g (10.0 mmol) of N-vinyl-acetamide and 0.3 ml (5.0 mmol) of acrylonitrile were mixed together in a 100 ml Schlenk tube, and 11.2 mg (0.07 mmol) of azobisisobutyronitrile was added thereto to react N-vinyl-acetamide and acrylonitrile at 60° C. for two hours. A reaction product was injected into 200 ml of methanol to perform reprecipitation, and a precipitate was filtered and dried, thereby obtaining 0.5 g of a polymer of Example 6. The yield was 45%.

¹H-NMR measurement was performed on the polymer of Example 6 in the same manner as on the polymer of Example 1 to specify the molecular structure. As a result, it was possible to confirm that the polymer of Example 6 was, similar to the polymer of Example 1, a copolymer having a structural unit represented by the general formula (1) (R in the general formula (1) was a methyl group) and a structural unit represented by the formula (2).

In addition, the composition ratio was calculated from the integrated value of each signal in the ¹H-NMR spectrum of Example 6. As a result, the content of the structural unit represented by the formula (2) that was included in the polymer of Example 6 was 18 mol %.

### Example 7

0.6 g (4.0 mmol) of N-vinyl-phenylamide and 1.0 ml (16.0 mmol) of acrylonitrile were mixed together in a 100 ml Schlenk tube, and 14.3 mg (0.09 mmol) of azobisisobutyronitrile was added thereto to react N-vinyl-phenylamide and acrylonitrile at 60° C. for two hours. A reaction product was injected into 200 ml of methanol to perform reprecipitation, and a precipitate was filtered and dried, thereby obtaining 0.9 g of a polymer of Example 7. The yield was 63%.

¹H-NMR measurement was performed on the polymer of Example 7 in the same manner as on the polymer of Example 1 to specify the molecular structure. As a result, it was possible to confirm that the polymer of Example 7 was a copolymer having a structural unit represented by the general formula (1) (R in the general formula (1) was a phenyl group) and a structural unit represented by the formula (2).

In addition, the composition ratio was calculated from the integrated value of each signal in the ¹H-NMR spectrum of Example 7. As a result, the content of the structural unit represented by the formula (2) that was included in the polymer of Example 7 was 85 mol %.

### Example 8

0.6 g (4.0 mmol) of N-vinyl-phenylamide and 0.5 ml (8.0 mmol) of acrylonitrile were mixed together in a 100 ml Schlenk tube, and 10.1 mg (0.06 mmol of azobisisobutyronitrile was added thereto to react N-vinyl-phenylamide and acrylonitrile at 60° C. for two hours. A reaction product was injected into 200 ml of methanol to perform reprecipitation, and a precipitate was filtered and dried, thereby obtaining 0.6 g of a polymer of Example 8. The yield was 59%.

¹H-NMR measurement was performed on the polymer of Example 8 in the same manner as on the polymer of Example 1 to specify the molecular structure. As a result, it was possible to confirm that the polymer of Example 8 was, similar to the polymer of Example 7, a copolymer having a structural unit represented by the general formula (1) (R in the general formula (1) was a phenyl group) and a structural unit represented by the formula (2).

In addition, the composition ratio was calculated from the integrated value of each signal in the ¹H-NMR spectrum of Example 8. As a result, the content of the structural unit represented by the formula (2) that was included in the polymer of Example 8 was 77 mol %.

### Example 9

1.2 g (8.0 mmol) of N-vinyl-phenylamide and 0.8 ml (12.0 mmol) of acrylonitrile were mixed together in a 100 ml Schlenk tube, and 18.1 mg (0.11 mmol of azobisisobutyronitrile was added thereto to react N-vinyl-phenylamide and acrylonitrile at 60° C. for two hours. A reaction product was injected into 200 ml of methanol to perform reprecipitation, and a precipitate was filtered and dried, thereby obtaining 1.3 g of a polymer of Example 9. The yield was 72%.

¹H-NMR measurement was performed on the polymer of Example 9 in the same manner as on the polymer of Example 1 to specify the molecular structure. As a result, it was possible to confirm that the polymer of Example 9 was, similar to the polymer of Example 7, a copolymer having a structural unit represented by the general formula (1) (R in the general formula (1) was a phenyl group) and a structural unit represented by the formula (2).

In addition, the composition ratio was calculated from the integrated value of each signal in the ¹H-NMR spectrum of Example 9. As a result, the content of the structural unit represented by the formula (2) that was included in the polymer of Example 9 was 63 mol %.

### Example 10

1.2 g (8.0 mmol) of N-vinyl-phenylamide and 0.5 ml (8.0 mmol) of acrylonitrile were mixed together in a 100 ml Schlenk tube, and 15.9 mg (1.10 mmol) of azobisisobutyronitrile was added thereto to react N-vinyl-phenylamide and acrylonitrile at 60° C. for two hours. A reaction product was injected into 200 ml of methanol to perform reprecipitation, and a precipitate was filtered and dried, thereby obtaining 1.0 g of a polymer of Example 10. The yield was 63%.

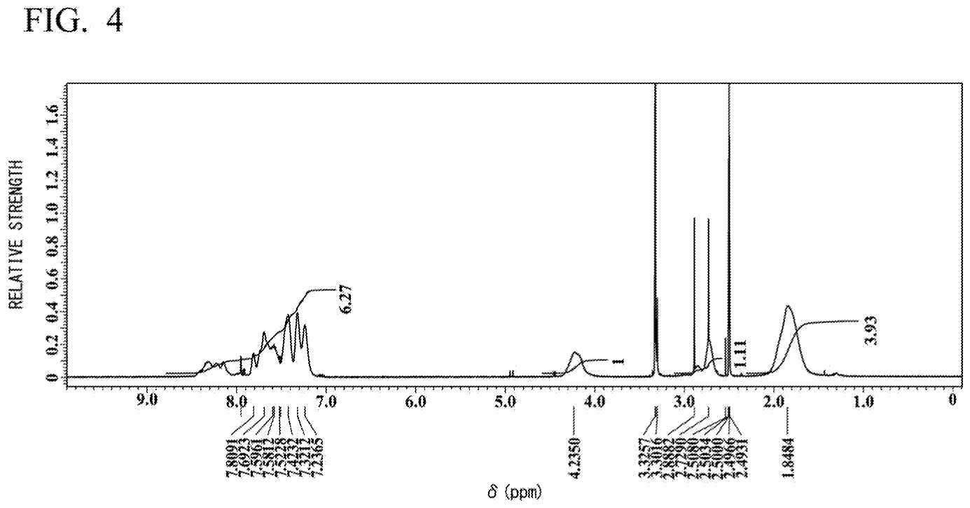

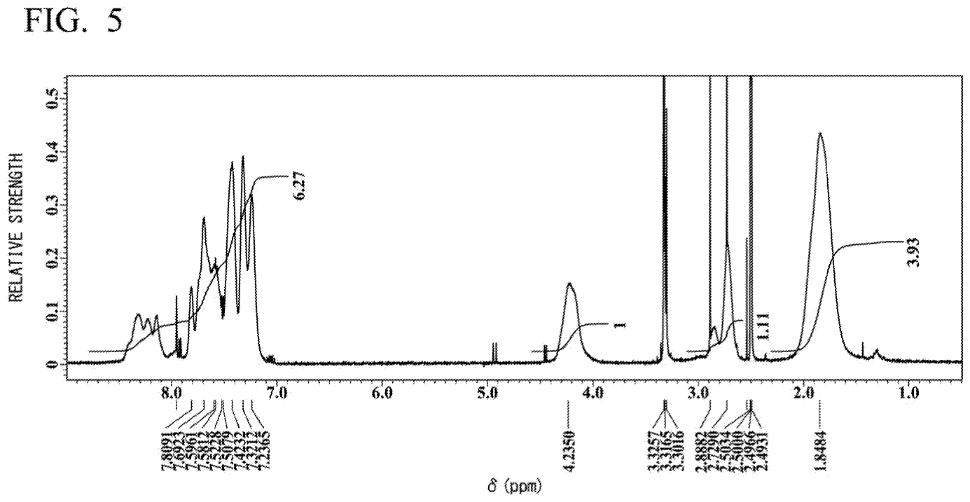

¹H-NMR measurement was performed on the polymer of Example 10 in the same manner as on the polymer of Example 1. FIG. 4 is the ¹H-NMR measurement chart of the polymer of Example 10. FIG. 5 is an enlarged view in which a part of FIG. 4 is enlarged. In addition, regarding the polymer of Example 10, the molecular structure is specified using the result of the ¹H-NMR measurement. As a result, it was possible to confirm that the polymer of Example 10 was, similar to the polymer of Example 7, a copolymer having a structural unit represented by the general formula (1) (R in the general formula (1) was a phenyl group) and a structural unit represented by the formula (2).

In addition, the composition ratio was calculated from the integrated value of each signal in the ¹H-NMR spectrum of Example 10. As a result, the content of the structural unit represented by the formula (2) that was included in the polymer of Example 10 was 50 mol %

### Example 11

1.8 g (12.0 mmol) of N-vinyl-phenylamide and 0.5 mi (8.0 mmol) of acrylonitrile were mixed together in a 100 ml Schlenk tube, and 21.8 mg (0.13 mmol) of azobisisobutyronitrile was added thereto to react N-vinyl-phenylamide and acrylonitrile at 60° C. for two hours. A reaction product was injected into 200 ml of methanol to perform reprecipitation, and a precipitate was filtered and dried, thereby obtaining 1.4 g of a polymer of Example 11. The yield was 64%.

¹H-NMR measurement was performed on the polymer of Example 11 in the same manner as on the polymer of Example 1 to specify the molecular structure. As a result, it was possible to confirm that the polymer of Example 11 was, similar to the polymer of Example 7, a copolymer having a structural unit represented by the general formula (1) (R in the general formula (1) was a phenyl group) and a structural unit represented by the formula (2).

In addition, the composition ratio was calculated from the integrated value of each signal in the ¹H-NMR spectrum of Example 11. As a result, the content of the structural unit represented by the formula (2) that was included in the polymer of Example 11 was 26 mol %.

### Example 12

1.8 g (12.0 mmol) of N-vinyl-phenylamide and 0.4 ml (6.0 mmol) of acrylonitrile were mixed together in a 100 ml Schlenk tube, and 20.7 mg (0.13 mmol) of azobisisobutyronitrile was added thereto to react N-vinyl-phenylamide and acrylonitrile at 60° C. for two hours. A reaction product was injected into 200 ml of methanol to perform reprecipitation, and a precipitate was filtered and dried, thereby obtaining 1.2 g of a polymer of Example 12. The yield was 58%.

¹H-NMR measurement was performed on the polymer of Example 12 in the same manner as on the polymer of Example 1 to specify the molecular structure. As a result, it was possible to confirm that the polymer of Example 12 was, similar to the polymer of Example 7, a copolymer having a structural unit represented by the general formula (1) (R in the general formula (I) was a phenyl group) and a structural unit represented by the formula (2).

In addition, the composition ratio was calculated from the integrated value of each signal in the ¹H-NMR spectrum of Example 12. As a result, the content of the structural unit represented by the formula (2) that was included in the polymer of Example 12 was 16 mmol %.

### Example 13

0.1 g (2.0 mmol) of N-vinyl-formamide and 0.7 mil (10.0 mmol) of acrylonitrile were mixed together in a 100 ml Schlenk tube, and 5.4 μg (0.03 mmol) of azobisisobutyronitrile was added thereto to react N-vinyl-formamide and acrylonitrile at 60° C. for two hours. A reaction product was injected into 200 mi of methanol to perform reprecipitation, and a precipitate was filtered and dried, thereby obtaining 0.5 g of a polymer of Example 13. The yield was 68%.

¹H-NMR measurement was performed on the polymer of Example 13 in the same manner as on the polymer of Example 1 to specify the molecular structure. As a result, it was possible to confirm that the polymer of Example 13 was a copolymer having a structural unit represented by the general formula (1) (R in the general formula (1) was a hydrogen atom) and a structural unit represented by the formula (2).

In addition, the composition ratio was calculated from the integrated value of each signal in the ¹H-NMR spectrum of Example 13. As a result, the content of the structural unit represented by the formula (2) that was included in the polymer of Example 13 was 83 mol %.

### Example 14

0.4 g (5.0 mmol) of N-vinyl-formamide and 0.7 ml (10.0 mmol) of acrylonitrile were mixed together in a 100 ml Schlenk tube, and 7.1 mg (0.04 mmol) of azobisisobutyronitrile was added thereto to react N-vinyl-formamide and acrylonitrile at 60° C. for two hours. A reaction product was injected into 200 ml of methanol to perform reprecipitation, and a precipitate was filtered and dried, thereby obtaining 0.7 g of a polymer of Example 14. The yield was 74%.

¹H-NMR measurement was performed on the polymer of Example 14 in the same manner as on the polymer of Example 1 to specify the molecular structure. As a result, it was possible to confirm that the polymer of Example 14 was, similar to the polymer of Example 13, a copolymer having a structural unit represented by the general formula (1) (R in the general formula (1) was a hydrogen atom) and a structural unit represented by the formula (2).

In addition, the composition ratio was calculated from the integrated value of each signal in the ¹H-NMR spectrum of Example 14. As a result, the content of the structural unit represented by the formula (2) that was included in the polymer of Example 14 was 69 mol %.

### Example 15

0.7 g (10.0 mmol) of N-vinyl-formamide and 0.7 ml (10.0 mmol) of acrylonitrile were mixed together in a (10 mil Schlenk tube, and 9.9 mg (0.06 mmol) of azobisisobutyronitrile was added thereto to react N-vinyl-formamide and acrylonitrile at 60° C. for two hours. A reaction product was injected into 200 ml of methanol to perform reprecipitation, and a precipitate was filtered and dried, thereby obtaining 1.0 g of a polymer of Example 15. The yield was 79%.

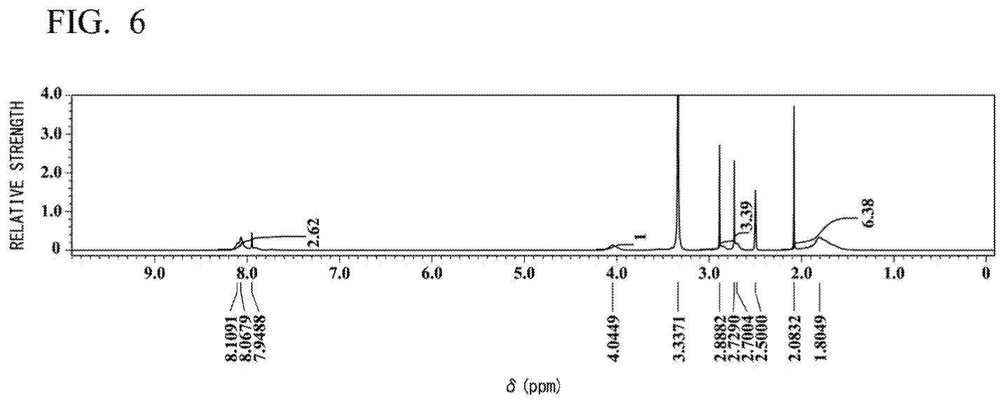

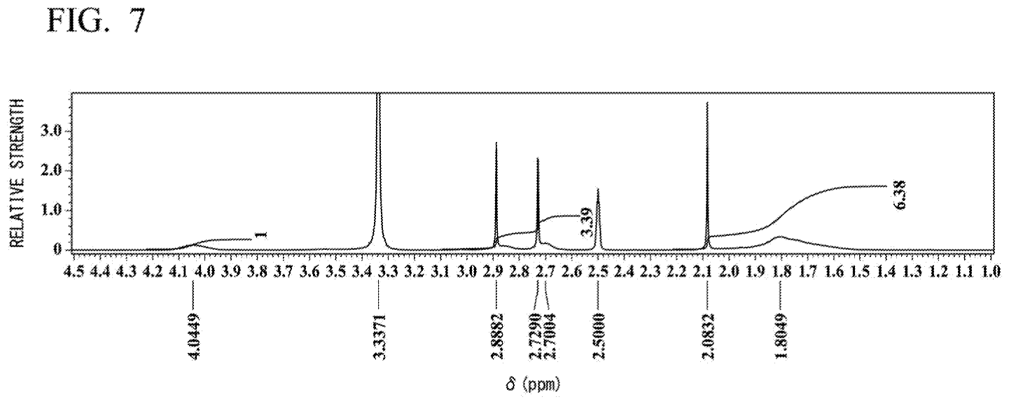

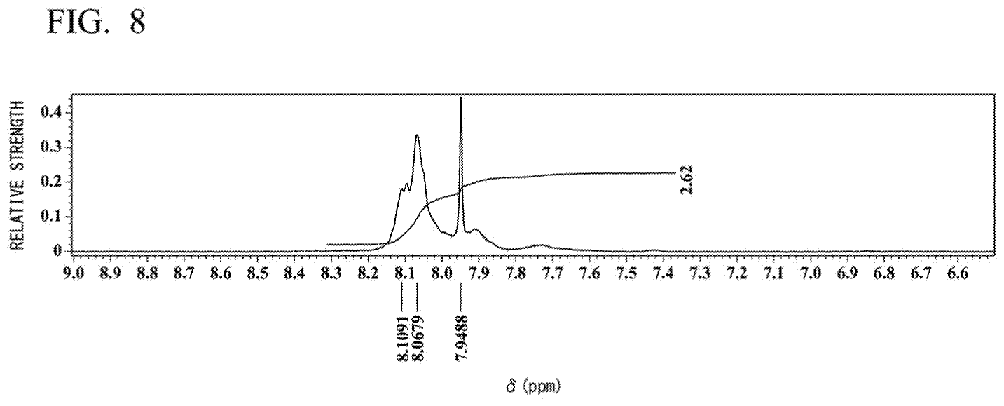

¹H-NMR measurement was performed on the polymer of Example 15 in the same manner as on the polymer of Example 1. FIG. 6 is the ¹H-NMR measurement chart of the polymer of Example 15. FIG. 7 and FIG. 8 are enlarged views in which a part of FIG. 6 is enlarged. In addition, regarding the polymer of Example 15, the molecular structure is specified using the result of the #H-NMR measurement. As a result, it was possible to confirm that the polymer of Example 15 was, similar to the polymer of Example 13, a copolymer having a structural unit represented by the general formula (1) (R in the general formula (1) was a hydrogen atom) and a structural unit represented by the formula (2). In addition, the composition ratio was calculated from the integrated value of each signal in the ¹H-NMR spectrum of Example 15. As a result, the content of the structural unit represented by the formula (2) that was included in the polymer of Example 15 was 56 mol %.

### Example 16

0.7 g (10.0 mmol) of N-vinyl-formamide and 0.4 ml (6.0 mmol) of acrylonitrile were mixed together in a 100 mi Schlenk tube, and 8.2 mg (0.05 mmol) of azobisisobutyronitrile was added thereto to react N-vinyl-formamide and acrylonitrile at 60° C. for two hours. A reaction product was injected into 200 ml of methanol to perform reprecipitation, and a precipitate was filtered and dried, thereby obtaining 0.7 g of a polymer of Example 16. The yield was 65%.

¹H-NMR measurement was performed on the polymer of Example 16 in the same manner as on the polymer of Example 1 to specify the molecular structure. As a result, it was possible to confirm that the polymer of Example 16 was, similar to the polymer of Example 13, a copolymer having a structural unit represented by the general formula (1) (R in the general formula (1) was a hydrogen atom) and a structural unit represented by the formula (2).

In addition, the composition ratio was calculated from the integrated value of each signal in the ¹H-NMR spectrum of Example 16. As a result, the content of the structural unit represented by the formula (2) that was included in the polymer of Example 16 was 43 mol %.

### Example 17

0.7 g (10.0 mmol) of N-vinyl-formamide and 0.4 ml (6.0 mmol) of acrylonitrile were mixed together in a 100 mil Schlenk tube, and 8.2 mg (0.05 mmol) of azobisisobutyronitrile was added thereto to react N-vinyl-formamide and acrylonitrile at 60° C. for two hours. A reaction product was injected into 200 ml of methanol to perform reprecipitation, and a precipitate was filtered and dried, thereby obtaining 0.7 g of a polymer of Example 17. The yield was 65%.

¹H-NMR measurement was performed on the polymer of Example 17 in the same manner as on the polymer of Example 1 to specify the molecular structure. As a result, it was possible to confirm that the polymer of Example 17 was, similar to the polymer of Example 13, a copolymer having a structural unit represented by the general formula (1) (R in the general formula (1) was a hydrogen atom) and a structural unit represented by the formula (2).

In addition, the composition ratio was calculated from the integrated value of each signal in the ¹H-NMR spectrum of Example 17. As a result, the content of the structural unit represented by the formula (2) that was included in the polymer of Example 17 was 20 mol %.

### Example 18

0.3 g (2.0 mmol) of N-vinyl-2,2-dimethylpropanamide and 0.4 ml (6.0 mmol) of acrylonitrile were mixed together in a 100 ml Schlenk tube, and 4.6 mg (0.03 mmol) of azobisisobutyronitrile was added thereto to react N-vinyl-2,2-dimethylpropanamide and acrylonitrile at 60° C. for two hours. A reaction product was injected into 200 ml of methanol to perform reprecipitation, and a precipitate was filtered and dried, thereby obtaining 0.3 g of a polymer of Example 18. The yield was 59%.

¹H-NMR measurement was performed on the polymer of Example 18 in the same manner as on the polymer of Example 1 to specify the molecular structure. As a result, it was possible to confirm that the polymer of Example 18 was a copolymer having a structural unit represented by the general formula (1) (R in the general formula (1) was a (trimethyl)methyl group) and a structural unit represented by the formula (2).

In addition, the composition ratio was calculated from the integrated value of each signal in the ¹H-NMR spectrum of Example 18. As a result, the content of the structural unit represented by the formula (2) that was included in the polymer of Example 18 was 80 mol %.

### Example 19

0.4 g (3.0 mmol) of N-vinyl-2,2-dimethylpropanamide and 0.4 ml (6.0 mmol) of acrylonitrile were mixed together in a 100 ml Schlenk tube, and 4.6 mg (0.03 mmol) of azobisisobutyronitrile was added thereto to react N-vinyl-2,2-dimethylpropanamide and acrylonitrile at 60′C for two hours. A reaction product was injected into 200 ml of methanol to perform reprecipitation, and a precipitate was filtered and dried, thereby obtaining 0.3 g of a polymer of Example 19. The yield was 59%.

¹H-NMR measurement was performed on the polymer of Example 19 in the same manner as on the polymer of Example 1 to specify the molecular structure. As a result, it was possible to confirm that the polymer of Example 19 was, similar to the polymer of Example 18, a copolymer having a structural unit represented by the general formula (1) (R in the general formula (1) was a (trimethyl)methyl group) and a structural unit represented by the formula (2).

In addition, the composition ratio was calculated from the integrated value of each signal in the ¹H-NMR spectrum of Example 19. As a result, the content of the structural unit represented by the formula (2) that was included in the polymer of Example 19 was 63 mol %.

### Example 20

0.8 g (6.0 mmol) of N-vinyl-2,2-dimethylpropanamide and 0.4 ml (6.0 mmol) of acrylonitrile were mixed together in a 100 ml Schlenk tube, and 8.7 mg (0.05 mmol) of azobisisobutyronitrile was added thereto to react N-vinyl-2,2-dimethylpropanamide and acrylonitrile at 60′C for two hours. A reaction product was injected into 200 ml of methanol to perform reprecipitation, and a precipitate was filtered and dried, thereby obtaining 0.7 g of a polymer of Example 20. The yield was 63%.

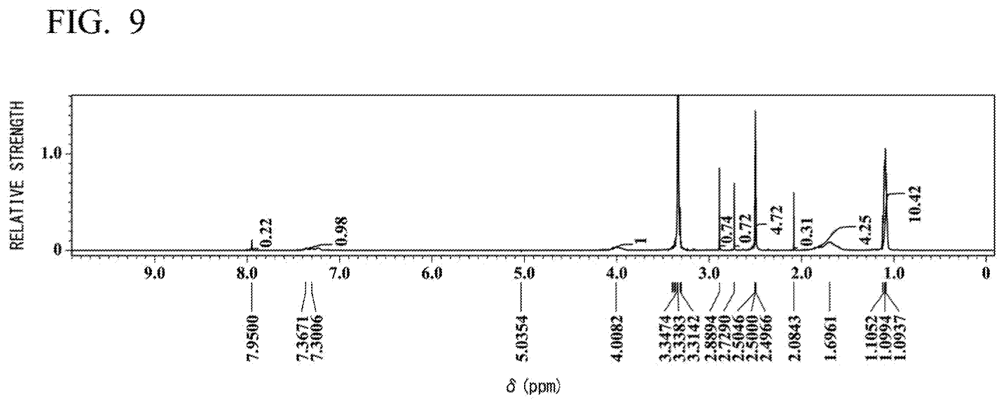

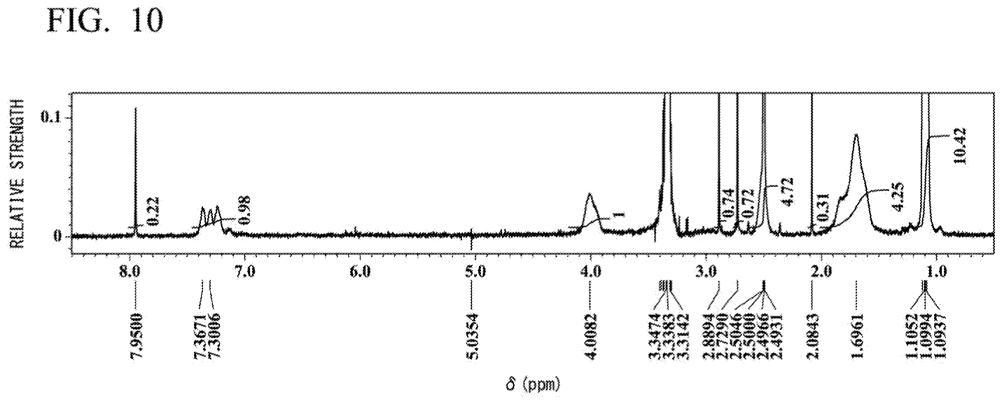

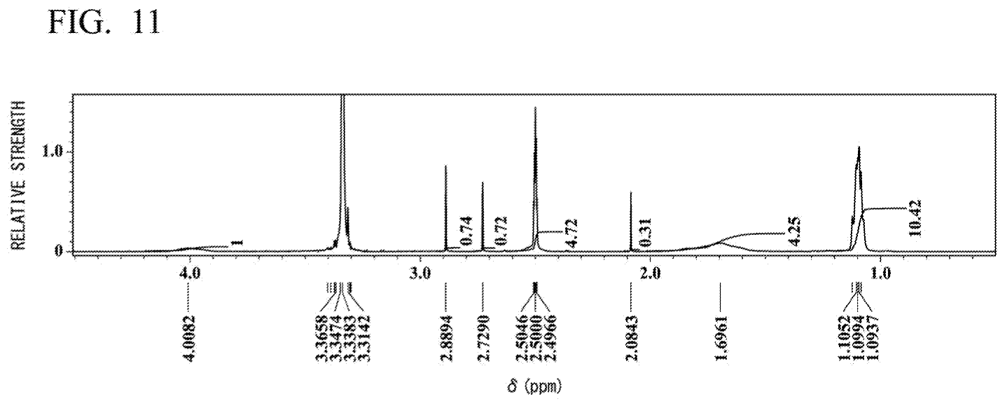

¹H-NMR measurement was performed on the polymer of Example 20 in the same manner as on the polymer of Example 1 to specify the molecular structure. FIG. 9 is the ¹H-NMR measurement chart of the polymer of Example 20. FIG. 10 and FIG. 11 are enlarged views in which a part of FIG. 9 is enlarged. In addition, regarding the polymer of Example 20, the molecular structure is specified using the result of the ¹H-NMR measurement. As a result, it was possible to confirm that the polymer of Example 20 was, similar to the polymer of Example 18, a copolymer having a structural unit represented by the general formula (1) (R in the general formula (1) was a (trimethyl)methyl group) and a structural unit represented by the formula (2).

In addition, the composition ratio was calculated from the integrated value of each signal in the ¹H-NMR spectrum of Example 20. As a result, the content of the structural unit represented by the formula (2) that was included in the polymer of Example 20 was 46 mol %.

### Example 21

0.8 g (6.0 mmol) of N-vinyl-2,2-dimethylpropanamide and 0.2 ml (3.0 mmol) of acrylonitrile were mixed together in a 100 ml Schlenk tube, and 7.4 mg (0.04 mmol) of azobisisobutyronitrile was added thereto to react N-vinyl-2,2-dimethylpropanamide and acrylonitrile at 60° C. for two hours. A reaction product was injected into 200 mi of methanol to perform reprecipitation, and a precipitate was filtered and dried, thereby obtaining 0.7 g of a polymer of Example 21. The yield was 72%.

¹H-NMR measurement was performed on the polymer of Example 21 in the same manner as on the polymer of Example 1 to specify the molecular structure. As a result, it was possible to confirm that the polymer of Example 21 was, similar to the polymer of Example 18, a copolymer having a structural unit represented by the general formula (1) (R in the general formula (1) was a (trimethyl)methyl group) and a structural unit represented by the formula (2).

In addition, the composition ratio was calculated from the integrated value of each signal in the ¹H-NMR spectrum of Example 21. As a result, the content of the structural unit represented by the formula (2) that was included in the polymer of Example 21 was 33 mol %.

### Example 22

0.8 g (6.0 mmol) of N-vinyl-2,2-dimethylpropanamide and 0.1 ml (2.0 mmol) of acrylonitrile were mixed together in a 100 ml Schlenk tube, and 7.0 mg (0.04 mmol) of azobisisobutyronitrile was added thereto to react N-vinyl-2,2-dimethylpropanamide and acrylonitrile at 60′C for two hours. A reaction product was injected into 200 ml of methanol to perform reprecipitation, and a precipitate was filtered and dried, thereby obtaining 0.6 g of a polymer of Example 22. The yield was 69%.

¹H-NMR measurement was performed on the polymer of Example 22 in the same manner as on the polymer of Example 1 to specify the molecular structure. As a result, it was possible to confirm that the polymer of Example 22 was, similar to the polymer of Example 18, a copolymer having a structural unit represented by the general formula (1) (R in the general formula (1) was a (trimethyl)methyl group) and a structural unit represented by the formula (2).

In addition, the composition ratio was calculated from the integrated value of each signal in the ¹H-NMR spectrum of Example 22. As a result, the content of the structural unit represented by the formula (2) that was included in the polymer of Example 22 was 19 mol %.

### Example 23

0.7 g (4.0 mmol) of N-vinyl-3-cyanophenylamide and 0.8 ml (12.0 mmol) of acrylonitrile were mixed together in a 100 ml Schlenk tube, and 10.6 mg (0.06 mmol) of azobisisobutyronitrile was added thereto to react N-vinyl-3-cyanophenylamide and acrylonitrile at 60° C. for two hours. A reaction product was injected into 200 mi of methanol to perform reprecipitation, and a precipitate was filtered and dried, thereby obtaining 0.8 g of a polymer of Example 23. The yield was 60%.

¹H-NMR measurement was performed on the polymer of Example 23 in the same manner as on the polymer of Example 1 to specify the molecular structure. As a result, it was possible to confirm that the polymer of Example 23 was a copolymer having a structural unit represented by the general formula (1) (R in the general formula (1) was a 3-cyanophenyl group) and a structural unit represented by the formula (2).

In addition, the composition ratio was calculated from the integrated value of each signal in the ¹H-NMR spectrum of Example 23. As a result, the content of the structural unit represented by the formula (2) that was included in the polymer of Example 23 was 82 mol %.

### Example 24

0.7 g (4.0 mmol) of N-vinyl-3-cyanophenylamide and 0.5 ml (8.0 mmol) of acrylonitrile were mixed together in a 100 ml Schlenk tube, and 10.6 mg (0.06 mmol) of azobisisobutyronitrile was added thereto to react N-vinyl-3-cyanophenylamide and acrylonitrile at 60′C for two hours. A reaction product was injected into 200 ml of methanol to perform reprecipitation, and a precipitate was filtered and dried, thereby obtaining 0.8 g of a polymer of Example 24. The yield was 60%.

¹H-NMR measurement was performed on the polymer of Example 24 in the same manner as on the polymer of Example 1 to specify the molecular structure. As a result, it was possible to confirm that the polymer of Example 24 was, similar to the polymer of Example 23, a copolymer having a structural unit represented by the general formula (1) (R in the general formula (1) was a 3-cyanophenyl group) and a structural unit represented by the formula (2).

In addition, the composition ratio was calculated from the integrated value of each signal in the ¹H-NMR spectrum of Example 24. As a result, the content of the structural unit represented by the formula (2) that was included in the polymer of Example 24 was 66 mol %.

### Example 25

0.7 g (4.0 mmol) of N-vinyl-3-cyanophenylamide and 0.3 ml (4.0 mmol of acrylonitrile were mixed together in a 100 ml Schlenk tube, and 7.3 mg (0.04 mmol) of azobisisobutyronitrile was added thereto to react N-vinyl-3-cyanophenylamide and acrylonitrile at 60° C. for two hours. A reaction product was injected into 200 mi of methanol to perform reprecipitation, and a precipitate was filtered and dried, thereby obtaining 0.5 g of a polymer of Example 25. The yield was 49%.

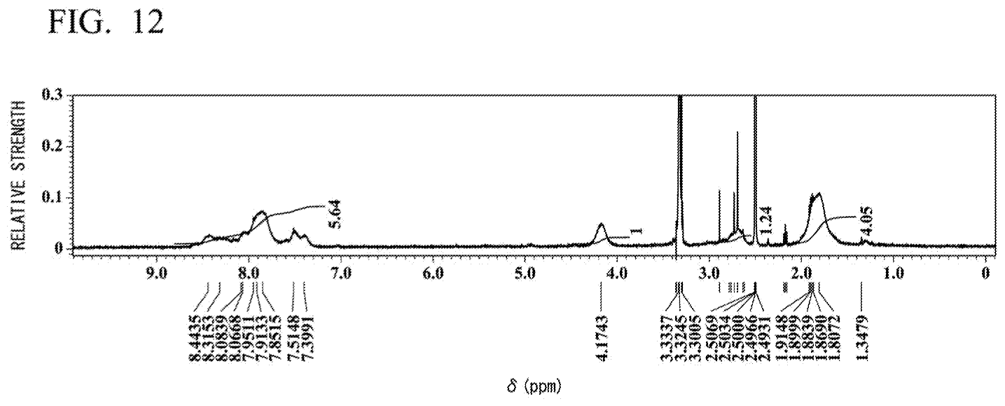

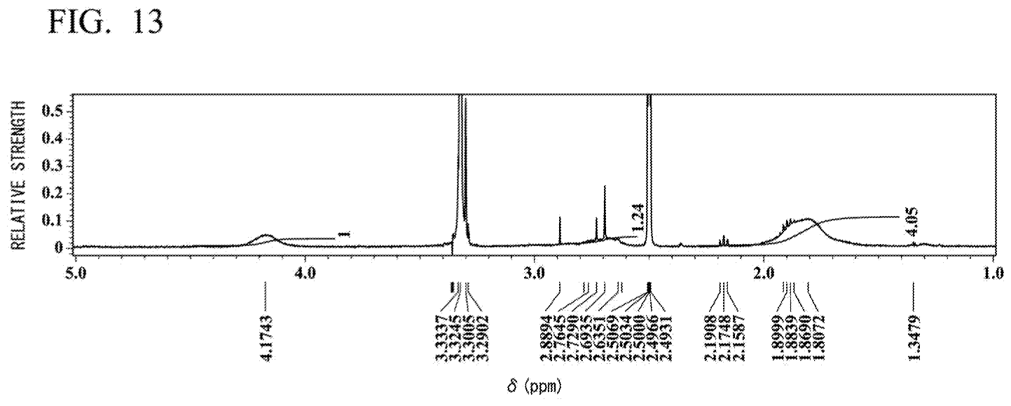

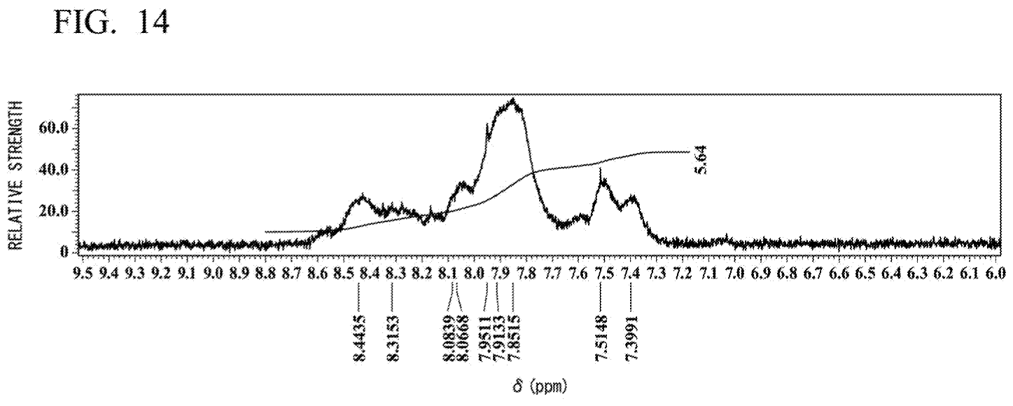

¹H-NMR measurement was performed on the polymer of Example 25 in the same manner as on the polymer of Example 1 to specify the molecular structure. FIG. 12 is the ¹H-NMR measurement chart of the polymer of Example 25. FIG. 13 and FIG. 14 are enlarged views in which apart of FIG. 12 is enlarged. In addition, regarding the polymer of Example 25, the molecular structure is specified using the result of the ¹H-NMR measurement. As a result, it was possible to confirm that the polymer of Example 25 was, similar to the polymer of Example 23, a copolymer having a structural unit represented by the general formula (1) (R in the general formula (1) was a 3-cyanophenyl group) and a structural unit represented by the formula (2).

In addition, the composition ratio was calculated from the integrated value of each signal in the ¹H-NMR spectrum of Example 25. As a result, the content of the structural unit represented by the formula (2) that was included in the polymer of Example 25 was 50 mol %.

### Example 26

1.4 g (8.0 mmol) of N-vinyl-3-cyanophenylamide and 0.3 ml (4.0 mmol) of acrylonitrile were mixed together in a 100 mil Schlenk tube, and 12.7 mg (0.08 mmol) of azobisisobutyronitrile was added thereto to react N-vinyl-3-cyanophenylamide and acrylonitrile at 60° C. for two hours. A reaction product was injected into 20) ml of methanol to perform reprecipitation, and a precipitate was filtered and dried, thereby obtaining 0.7 g of a polymer of Example 26. The yield was 42%.

¹H-NMR measurement was performed on the polymer of Example 26 in the same manner as on the polymer of Example 1 to specify the molecular structure. As a result, it was possible to confirm that the polymer of Example 26 was, similar to the polymer of Example 23, a copolymer having a structural unit represented by the general formula (1) (R in the general formula (1) was a 3-cyanophenyl group) and a structural unit represented by the formula (2).

In addition, the composition ratio was calculated from the integrated value of each signal in the ¹H-NMR spectrum of Example 26. As a result, the content of the structural unit represented by the formula (2) that was included in the polymer of Example 26 was 31 mol %.

### Example 27

2.1 g (12.0 mmol) of N-vinyl-3-cyanophenylamide and 0.3 ml (4.0 mmol) of acrylonitrile were mixed together in a 100 ml Schlenk tube, and 18.2 mg (0.11 mmol) of azobisisobutyronitrile was added thereto to react N-vinyl-3-cyanophenylamide and acrylonitrile at 60° C. for two hours. A reaction product was injected into 200 mil of methanol to perform reprecipitation, and a precipitate was filtered and dried, thereby obtaining 1.0 g of a polymer of Example 27. The yield was 43%.

¹H-NMR measurement was performed on the polymer of Example 27 in the same manner as on the polymer of Example 1 to specify the molecular structure. As a result, it was possible to confirm that the polymer of Example 27 was, similar to the polymer of Example 23, a copolymer having a structural unit represented by the general formula (1) (R in the general formula (1) was a 3-cyanophenyl group) and a structural unit represented by the formula (2).

In addition, the composition ratio was calculated from the integrated value of each signal in the ¹H-NMR spectrum of Example 27. As a result, the content of the structural unit represented by the formula (2) that was included in the polymer of Example 27 was 19 mol %.

### Comparative Example 1

Polyacrylonitrile (trade name: 181315, manufactured by Sigma-Aldrich) was used as a polymer of Comparative Example 1.

### Comparative Example 2

Poly(acrylonitrile-CO-methyl acrylate) (trade name: 517941, manufactured by Sigma-Aldrich) was used as a polymer of Comparative Example 2.

Regarding each of the polymers of Example 1 to Example 27 obtained as described above, R in the structural unit represented by the general formula (1) and the content of the structural unit represented by the formula (2) are shown in Table 1.

In addition, the compound names of the polymers of Comparative Example 1 and Comparative Example 2 and the contents of the structural units represented by the formula (2) in the polymers are each shown in Table 1.

TABLE 1

| | R or polymer material | Content of structural | Glass | |
|---|---|---|---|---|
| | in structural | unit represented | transition | |
| | unit represented | by formula (2) | temperature | d₃₃ |
| | by formula (1) | (mol %) | (° C.) | (pC/N) |
| Example 1 | R = methyl group | 83 | 118 | 2.6 |
| Example 2 | R = methyl group | 74 | 131 | 4.4 |
| Example 3 | R = methyl group | 60 | 139 | 5.3 |
| Example 4 | R = methyl group | 44 | 149 | 4.9 |
| Example 5 | R = methyl group | 29 | 155 | 3.4 |
| Example 6 | R = methyl group | 18 | 163 | 1.5 |
| Example 7 | R = phenyl group | 85 | 124 | 2.9 |
| Example 8 | R = phenyl group | 77 | 135 | 3.3 |
| Example 9 | R = phenyl group | 63 | 159 | 5.1 |
| Example 10 | R = phenyl group | 50 | 184 | 6.2 |
| Example 11 | R = phenyl group | 26 | 201 | 5.6 |
| Example 12 | R = phenyl group | 16 | 209 | 2.2 |
| Example 13 | R = hydrogen atom | 83 | 112 | 1.5 |
| Example 14 | R = hydrogen atom | 69 | 123 | 3.1 |
| Example 15 | R = hydrogen atom | 56 | 133 | 3.7 |
| Example 16 | R = hydrogen atom | 43 | 144 | 3.7 |
| Example 17 | R = hydrogen atom | 20 | 162 | 3.2 |
| Example 18 | R = (trimethyl) methyl | 80 | 115 | 3.4 |
| | group | | | |
| Example 19 | R = (trimethyl) methyl | 63 | 130 | 4.5 |
| | group | | | |
| Example 20 | R = (trimethyl) methyl | 46 | 145 | 4.3 |
| | group | | | |
| Example 21 | R = (trimethyl) methyl | 33 | 156 | 3.2 |
| | group | | | |
| Example 22 | R = (trimethyl) methyl | 19 | 168 | 1.5 |
| | group | | | |
| Example 23 | R = 3-cyanophenyl group | 82 | 130 | 2.0 |
| Example 24 | R = 3-cyanophenyl group | 66 | 159 | 4.5 |
| Example 25 | R = 3-cyanophenyl group | 50 | 188 | 4.8 |
| Example 26 | R = 3-cyanophenyl group | 31 | 222 | 4.1 |
| Example 27 | R = 3-cyanophenyl group | 19 | 244 | 2.5 |
| Comparative | Polyacrylonitrile | 100 | 98 | 0.8 |
| Example 1 | | | | |
| Comparative | Poly(acrylonitrile-co- | 96 | 97 | 0.7 |
| Example 2 | methyl acrylate) | | | |

Regarding each of the polymers of Example 1 to Example 27. Comparative Example 1 and Comparative Example 2, the glass transition temperature (Tg) was measured by a method to be described below, and the result is shown in Table 1.

### (Method for Measuring Glass Transition Temperature (Tg))

Heating and cooling operations were performed using a high-sensitivity differential scanning calorimeter (trade name: DSC6200, manufactured by Seiko Instruments Inc.) under a nitrogen atmosphere from 30° C. to 200° C. at a heating rate of 20° C./minute, from 200° C. to 30° C. at a cooling rate of 40° C./minute and from 30° C. to 200° C. at a heating rate of 20° C.:/minute, and the inflection point at the time of the second heating was obtained and regarded as the glass transition temperature (Tg).

In addition, a piezoelectric film was produced using each of the polymers of Example 1 to Example 27, Comparative Example 1 and Comparative Example 2 as a piezoelectric material by a method to be described below, and the piezoelectric constant d₃₃ was measured. The result is shown in Table 1.

### (Production of Piezoelectric Film)

The piezoelectric material was dissolved in N,N-dimethylformamide, which was a solvent, to fabricate 20 mass % of a polymer solution (application liquid). The obtained polymer solution was applied onto a PET film (trade name: LUMIRROR (registered tradename), manufactured by Toray Industries, Inc.) as a base material so that the dried thickness reached 50 μm, thereby forming a coated film, After that, the coated film formed on the PET film was dried on a hot plate at 120° C. for six hours to remove the solvent in the coated film, thereby obtaining a piezoelectric material sheet.

The obtained piezoelectric material sheet was peeled off from the PET film, and an electrode made of aluminum was provided on each of one surface and the other surface of the piezoelectric material sheet by a vapor deposition method. After that, a high voltage power supply HARB-20R60 (manufactured by Matsusada Precision Inc.) and the electrodes on the piezoelectric material sheet were electrically connected together and held at 140° C. for 15 minutes in a state where an electric field of 100 MV/m was applied thereto. After that, the high voltage power supply and the electrodes were slowly cooled to room temperature under the application of the voltage, and a polling treatment was performed thereon, thereby obtaining a sheet-like piezoelectric film.

(Method for Measuring Piezoelectric Constant d₃₃)

The piezoelectric film was installed in a measuring instrument using a pin having a tip diameter of 1.5 mm as a sample fixing jig. As the measuring instrument of the piezoelectric constant d₃₃, a piezometer system PM200 manufactured by Piezotest Pte Ltd. was used.

The actual measurement value of the piezoelectric constant d₃₃ became a positive value or a negative value depending on whether the surface of the piezoelectric film to be measured was the front surface or the rear surface. In the present specification, as the value of the piezoelectric constant d₃₃, the absolute value of the actual measurement value is shown.

As shown in Table 1, it was possible to confirm that, in the polymers of Example 1 to Example 27, the glass transition temperatures (g) were high and the heat resistance was favorable compared with those of the polymers of Comparative Example 1 and Comparative Example 2.

In addition, the piezoelectric films of Example 1 to Example 27 containing the polymers of Example 1 to Example 27 had a high piezoelectric constant dl and favorable piezoelectric characteristics compared with the piezoelectric film of Comparative Example 1 containing the polymer of Comparative Example 1 and the piezoelectric film of Comparative Example 2 containing the polymer of Comparative Example 2.

Particularly, in the piezoelectric films of Example 2 to Example 5, Example 8 to Example 11, Example 14 to Example 21 and Example 24 to Example 26 containing a polymer in which the content of the structural unit represented by the formula (2) was 20 to 80 mol %, the piezoelectric constants d₃₃ were high and the piezoelectric characteristics were favorable.

### INDUSTRIAL APPLICABILITY

The copolymer of the present invention can be used as a piezoelectric material from which a piezoelectric film having high heat resistance and piezoelectric characteristics can be obtained.

The piezoelectric material of the present invention contains the copolymer of the present invention, and a piezoelectric film having high heat resistance and piezoelectric characteristics can thus be obtained therefrom.

The piezoelectric film of the present invention contains the copolymer of the present invention. Therefore, the piezoelectric film of the present invention and the piezoelectric element of the present invention having the piezoelectric film of the present invention are excellent in terms of heat resistance and piezoelectric characteristics.

1. A copolymer having a structural unit represented by the following general formula (1) and a structural unit represented by the following formula (2), 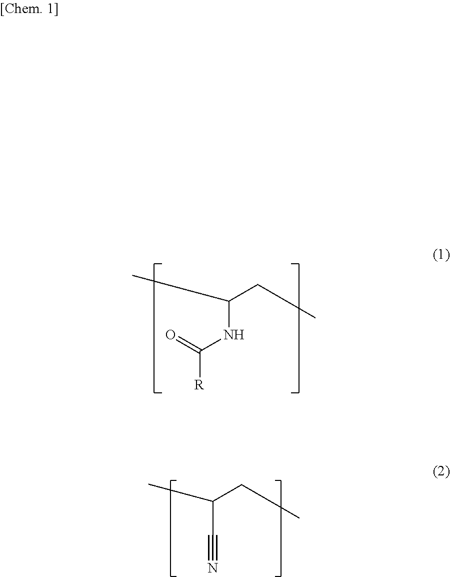
(in the general formula (1), R is any one selected from a hydrogen atom, a methyl group, an ethyl group, a methoxymethyl group, a propyl group, an isopropyl group, a cyclopropyl group, a butyl group, an isobutyl group, a (trimethyl)methyl group, a pentyl group, an isopentyl group, a t-pentyl group, a neopentyl group, a cyclopentyl group, a hexyl group, a cyclohexyl group, an adamantyl group, a phenyl group optionally having one to five substituents selected from a methyl group, an ethyl group, a methoxy group, an ethoxy group, a fluoro group, a trifluoromethyl group and a cyano group at any positions, an o-acetamidophenyl group, a m-acetamidophenyl group, a p-acetamidophenyl group, an o-benzamide group, a m-benzamide group, a p-benzamide group, an o-(methyl)benzamide group, a m-(methyl)benzamide group, a p-(methyl)benzamide group, an o-(N,N-dimethyl)benzamide group, a m-(N,N-dimethyl)benzamide group, a p-(N,N-dimethyl)benzamide group, a benzyl group optionally having one to five substituents selected from a methyl group, an ethyl group, a methoxy group, an ethoxy group, a fluoro group, a trifluoromethyl group and a cyano group at any positions and a phenoxymethyl group).

2. The copolymer according to claim 1,
wherein, in the general formula (1), R is any one of a hydrogen atom, a methyl group, a butyl group, a phenyl group and a cyanophenyl group.

3. The copolymer according to claim 1,
wherein a content of the structural unit represented by the formula (2) is 20 to 80 mol %.

4. A piezoelectric material comprising:
the copolymer according to claim 1.

5. A piezoelectric film comprising:
the copolymer according to claim 1.

6. A piezoelectric element comprising:
the piezoelectric film according to claim 5; and
an electrode disposed on a surface of the piezoelectric film.
